(19) United States
(12) Patent Application Publication
(10) Pub. No.: US 2015/0216164 A1
(43) Pub. Date: Aug. 6, 2015

(54) SPATIAL INHIBITORS, DETERRENTS AND REPELLENTS FOR MOSQUITOES AND MIDGES

(71) Applicant: Bedoukian Research, Inc., Danbury, CT (US)

(72) Inventors: Robert H. BEDOUKIAN, West Redding, CT (US); Paul J. WELDON, Baltimore, MD (US)

(21) Appl. No.: 14/689,526

(22) Filed: Apr. 17, 2015

Related U.S. Application Data
(63) Continuation of application No. 11/509,767, filed on Aug. 24, 2006, now abandoned.
(60) Provisional application No. 60/711,112, filed on Aug. 25, 2005.

(51) Int. Cl. A01N 35/04; A01N 31/02; A01N 35/02

(52) U.S. Cl. CPC A01N 35/04; A01N 35/02; A01N 31/02

(57) ABSTRACT

Certain components of citrus fruits and oxidation products of limonene are effective deterrents, repellents and/or spatial inhibitors for mosquitoes and biting midges. The compounds that have been found to be deterrents, repellents and inhibitors for mosquitoes and biting midges are neryl acetate, citronellyl acetate, geranyl acetate, hydroxy-p-cymene, citral, α-terpineol, citronellal, linaloyl acetate, citronellol, terpen-4-ol, tetrahydrocarvone, products of oxidized oxidized limonene inclusive of d- and l-carvone, (+) limonene oxide, (−) limonene oxide, cis and trans carveol, a diol and an aldehyde, and mixtures thereof.

### RELATED APPLICATIONS

This application is a continuation of U.S. patent application Ser. No. 11/509,767, filed Aug. 24, 2006, which claims priority from U.S. Provisional Application No. 60/711,112, filed Aug. 25, 2005, both of which are incorporated herein by reference in their entirety.

### BACKGROUND OF THE DISCLOSURE

1. Field of the Disclosure

The invention relates to improved compounds, compositions and systems for deterring or repelling mosquitoes and biting midges from a target, or providing a spatial inhibitor for preventing mosquitoes and biting midges from sensing or landing on a target, particularly a human target. The invention also provides a method of employing such compounds and compositions for deterring or repelling mosquitoes and biting midges from contact with targets or for inhibiting them from sensing or landing on a target.

2. Description of the Related Art

In the field of mosquito and biting midge control and repellency many compounds or substances have been employed. For example, DEET® has been employed as a mosquito and biting midge repellent. However, DEET® is a contact repellent that mosquitoes or biting midges avoid when they come into contact with it. Thus, DEET® is applied to the skin of a person to repel mosquitoes or biting midges when they contact the DEET®. However, to many persons DEET® can have irritating or toxic effects and cannot be applied to their skin. Citronella oil has also been shown to have relatively low efficacy for its intended use as a spatial inhibitor. Recently, it has been discovered that certain 3-methyl-1-alkene-3-ols, such as linalool, act as spatial inhibitors, i.e., these compounds inhibit the ability of mosquitoes and biting midges to sense a human target when these compounds are dispensed into an environment.

It has been observed that certain mammals and birds will generally roll on or wipe their integument or skin with fruit, leaves or other plant parts for the apparent purpose of deterring ectoparasites, a phenomenon known as anointing. For this purpose many animals have used lemons (Citrus limona), limes (Citrus aurantilolia) and other citrus fruits as the anointing materials. In many cases, the peels, oils or scents of these fruits are applied by the animals to their integument or skin for this purpose of deterring ectoparasites. The major or chief component of these citrus fruits is limonene (4-isopropenyl-1-methyl-cyclohexane) generally more than 55% and usually about 95%-99% in the peel of these fruits. From this it was assumed or inferred that limonene might be an effective repellent or spatial inhibitor for mosquitoes. However, when limonene was tested against mosquitoes it was not found to be either an effective repellent or spatial inhibitor.

In view of the potential for irritation or toxic effects from the use of DEET® there is a need for other mosquito and biting midge deterrents, repellents and/or spatial inhibitor, and especially for deterrents, repellents or inhibitors that are naturally occurring and provide low risk to consumers and user of such products.

### SUMMARY OF THE DISCLOSURE

It has been discovered that certain components of citrus fruits, peels, rinds or epicarps and oxidation products of the d-limonene contained in the fruit, as well as some closely related materials, are effective mosquito and biting midge deterrents, repellents and or spatial inhibitors for mosquitoes and biting midges. Thus according to this invention there is provided a method of deterring, repelling or inhibiting mosquitoes and biting midges from a human or an environmental area, the method comprising providing to the human or the environmental area a deterring/repelling/inhibiting effective amount of at least one compound selected from neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene, and mixtures thereof, with the proviso that for use as a mosquito and biting midge deterrent/repellent on a human, citral is not employed as the sole deterrent/repellent compound from this group of compounds, and citronellal is not employed as the sole deterrent/repellent, or deterrent/spatial inhibitor compound from this group of compounds. The products of oxidized limonene include, but are not limited to, d- and l-carvone, (+) limonene oxide, (−) limonene oxide, cis and trans carveol, a diol and an aldehyde.

The compounds that have been found to be particularly effective contact deterrents/repellents for mosquitoes and biting midges, feeding deterrents; repellents for mosquitoes and biting midges are neryl acetate, citronellyl acetate, geranyl acetate, neryl acetate, hydroxy-p-cymene, citral, α-terpineol, citronellal, linaloyl acetate, citronellol, d- and l-carvone, (+) limonene oxide, (−) limonene oxide, cis and trans carveol, terpen-4-ol, tetrahydrocarvone, and mixtures thereof, with the proviso that for use as a contact mosquito and biting midge deterrent/repellent citral is not employed as the sole deterrent/repellent component. The compounds neryl acetate, citronellyl acetate, geranyl acetate, citral, α-terpineol, terpinen-4-ol, citronellal, citronellol, linaloyl acetate, (+)/(−) limonene oxide, products of oxidized limonene, particularly d-carvone, l-carvone and cis and trans carveol, and mixtures thereof have been found to be particularly effective as spatial repellents/inhibitors for mosquitoes and biting midges. The compounds neryl acetate, hydroxy-p-cymene, citronellal, linaloyl acetate, geranyl acetate, α-terpineol, d-carvone, l-carvone, (+) and (−) limonene oxide, cis and trans carveol and tetrahydrocarvone, and mixtures thereof are especially effective as mosquito and biting midges contact repellents/deterrents.

The compounds may be formulated into suitable vehicles as topical deterrent, repellent or spatial inhibitor compositions. The use of the compounds of this invention for the aforementioned repellency and inhibitory purposes is, for example, but not limited to the following methods. For repelling mosquitoes and biting midges from a human, the method comprises applying to the skin of the human a repellency effective amount of at least one compound selected from neryl acetate, hydroxy-p-cymene, citral, citronellal, linaloyl acetate, geranyl acetate, α-terpineol, tetrahydrocarvone, products of oxidized limonene and mixtures thereof with the proviso that for use as a mosquito and biting midge deterrent/repellent on a human, citral in not employed as the sole deterrent/repellent compound from this group of compounds, and citronellal is not employed as the sole deterrent/repellent, or deterrent/spatial inhibitor compound from this group of compounds. For use as a spatial repellent/inhibitor the method comprises dispensing into an environmental area where one wants to provide such inhibiting effect, an inhibiting effective amount of at least one inhibitor compound selected from neryl acetate, citronellyl acetate, geranyl acetate, 8-hydroxy-p-cymene, citral, α-terpineol, terpinen-4-ol, citronellal, citronellol, linaloyl acetate, products of oxidized limonene, and mixtures thereof. The dispensing may be by way of evaporation of the compound from a vehicle, dispersion by an aerosol, or by incorporation of the compounds into granules or powders that can be scattered on the ground, and the like.

### BRIEF DESCRIPTION OF THE DRAWINGS

FIG. 1 is a graph of the feeding (feeding deterrent or contact repellency) results of mosquitoes for compounds (components of citrus oils) of this invention versus control as tested in the examples.

FIG. 2 is a graph of the flying (spatial inhibition or repellency) results of mosquitoes for compounds (components of citrus oils) of this invention versus control as tested in the examples.

FIG. 3 is a graph of the feeding (feeding deterrent or contact repellency) results of mosquitoes for compounds (oxidation products of limonene) of this invention versus control as tested in the examples.

FIG. 4 is a graph of the flying (spatial repellency) results of mosquitoes for compounds (oxidation products of limonene) of this invention versus control as tested in the examples.

FIG. 5 is a graph of the spatial inhibition/repellency results (% mosquitoes caught) of mosquitoes caught in an American Biophysics Mosquito Magnet Liberty Plus mosquito trap relative to a control without the repellency compounds of this invention.

### DESCRIPTION OF THE PREFERRED EMBODIMENTS

In accordance with this invention certain components of citrus fruits and the oxidation products of limonene have been discovered to be effective mosquito and biting midge deterrents, repellents and/or spatial inhibitors for mosquitoes and biting midges. The compounds that have been found to be feeding deterrents or contact repellents for mosquitoes and biting midge and/or spatial repellents or inhibitors for mosquitoes and biting midge are neryl acetate, citronellyl acetate, geranyl acetate, hydroxy-p-cymene, citral, α-terpineol, citronellal, linaloyl acetate, citronellol, terpen-4-ol, tetrahydrocarvone, products of oxidized limonene, and mixtures thereof, with the proviso that for use as a mosquito and biting midge deterrent/repellent on a human, citral is not employed as the sole deterrent/repellent compound from this group of compounds, and citronellal is not employed as the sole deterrent/repellent, or deterrent/spatial inhibitor compound from this group of compounds. The products of oxidized limonene include, but are not limited to, d- and l-carvone, (+) limonene oxide, (−) limonene oxide, cis and trans carveol, a diol and an aldehyde. The compounds neryl acetate, citronellal acetate, geranyl acetate, hydroxy-p-cymene, citral, α-terpineol, terpinen-4-ol, citronellal, citronellol, d-carvone, l-carvone, cis and trans carveol, linaloyl acetate, and (+)/(−) limonene oxide, and mixtures thereof have been found to be particularly effective as spatial inhibitors for mosquitoes and neryl acetate, hydroxy-p-cymene, citronellal, linaloyl acetate, geranyl acetate, α-terpineol, d-carvone, l-carvone, (+) and (−) limonene oxide, cis and trans carveol, tetrahydrocarvone, and mixtures thereof are especially effective as contact mosquito repellents. The compounds may be formulated into suitable deterrent, repellent compositions or into suitable spatial inhibitor compositions.

For mosquito and biting midge repellency, the repellency compounds of this invention may be formulated into any compositions suitable for application of a repellency effective amount of the repellent compound to the skin of a human, typically in an amount ranging from 0.5% to 75% by weight of the composition. For spatial inhibition of the ability of mosquitoes and biting midges to sense a target, the inhibitory compounds of this invention may be formulated into any suitable composition suitable to dispense a spatially inhibitory effective amount of the inhibitory compound into an environmental area in which it is desired to spatially inhibit mosquitoes and biting midges from being able to sense their targets. This inhibitory effective amount would typically range from 0.000005-0.010 grams/hr/ft² of the base area of the environmental area in which inhibition is to be sought.

It is to be realized that the active compounds of this invention may be employed in combination with other components recognized as mosquito deterrents, repellents and/or inhibitors, such as for example, including but not limited to, those spatial inhibitors and repellent compounds disclosed for example in U.S. Pat. No. 6,362,235; and U.S. Patent Application Publication No. 2005/0090563 A1. A preferred inhibitor compound that may be combined with the deterrent, repellent and or/inhibitor compounds of this invention is linalool, and especially d-linalool (which is also found in citrus fruits).

The deterrent/repellent/inhibitor compounds of this invention may be synthesized or may be obtained from natural oils, such as for example, including but not limited to, coriander, spearmint, lemongrass, caraway, and the like.

The deterrent/repellent/inhibitor compounds of this invention may be formulated, as described herein before, into any suitable delivery means or system. For example, the formulated composition may be formulated into such suitable delivery systems or vehicle, including but not limited to, delivery systems such as compositions in heated or unheated evaporative devices such as candles or compositions placed in fan driven apparatus, compositions for placement on floors or carpets or the ground, compositions in wrist or ankle bands or the like, and compositions in absorbent materials that may be scattered on the ground or floor. The many other forms in which the active compounds of this invention may be delivered will be readily apparent to those skilled in the art. Thus, the invention comprises a composition for delivery of a deterring/repelling/inhibiting effective amount of a deterring/repelling/inhibiting compound effective against mosquitoes or biting midges, said composition comprising (a) at least one compound selected from the group consisting of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and mixtures thereof, with the proviso that for use as a mosquito and biting midge deterrent/repellent on a human, citral is not employed as the sole deterrent/repellent compound from this group of compounds, and citronellal is not employed as the sole deterrent, repellent, or spatial inhibitor compound from this group of compounds; and (b) a carrier vehicle for delivery of said at least one compound to a human or an environment.

The following tests were employed to illustrate the efficacy of the compounds of this invention to effectively act as mosquito deterrents, repellents or as spatial inhibitors for mosquitoes. The test was conducted at 0900-2100 hours in a walk-in incubator (26° C., 63-80% RH) illuminated by fluorescent lights. Mosquitoes were tested in a two-piece Plexiglas module designed to assess their response to feeding deterrents. The bottom piece of the module was 40×7×4-cm hollow platform supporting six circular wells (diameter=3.8 cm, depth=6 mm) Water (40° C.) flowed through the central cavity of the platform at a rate of 215 ml/min. The top piece of the module consisted of six 4.5×4.0×5.0 cm chambers, the floors of which were fitted with a sliding door positioned over a circular opening 3.5 cm in diameter. Mosquitoes were introduced through an aperture 1 cm in diameter on the front wall of the chambers. For each test, five female mosquitoes (Aedes aegypti) were aspirated into each of five chambers of the top module piece and the apertures were plugged with corks wrapped in plastic film. The wells on the bottom piece of the module were filled with 7 ml of 10% sucrose solution containing ATP (2.9 mg/ml). To each well, 75 μl of green dye (McCormick Food, Hunt Valley, Md.) were added so that those mosquitoes imbibing the sugar solution could be identified when crushed at the end of the tests. Each membrane received 50 μl of acetone or experimental compound solution, applied to 9.6 cm² circular area on 0.1 mm-thick membranes made of nylon mesh in a silicone matrix. The membranes were then placed over each well in contact with the sugar solution.

The circular openings on the floor of each chamber of the top piece of the module were aligned with each membrane-covered well of the bottom piece. The sliding floors of the chambers were then opened allowing mosquitoes access to the membranes. The number of mosquitoes landing on the membranes, and those flying within the apparatus, were recorded each minute for five minutes. After five minutes, any mosquitoes remaining on the membranes were removed with a metal wire, and the door of the floor of each chamber was closed. The top piece of the module was then placed into a freezer for 20 minutes. In the test designed to assess feeding, mosquitoes were removed from the frozen module, crushed on white paper towels, and examined for the presence of green dye to indicate that feeding had occurred. The proportions of mosquitoes feeding per trial were analyzed using a standard generalized linear model with a logit link. Landing and flying scores are repeated measures; five reading were obtained for groups of five mosquitoes. Thus, to maintain independence among the data, the five readings were summed, and then the sums divided by 25 (the maximum score in each category) to create proportions of mosquitoes landing and flying. The proportions were then transferred using the standard variance stabilizing transformation for proportions (sin⁻¹ √y, where y is the proportion), and analyzed using ANOVA (Analysis of Variables)

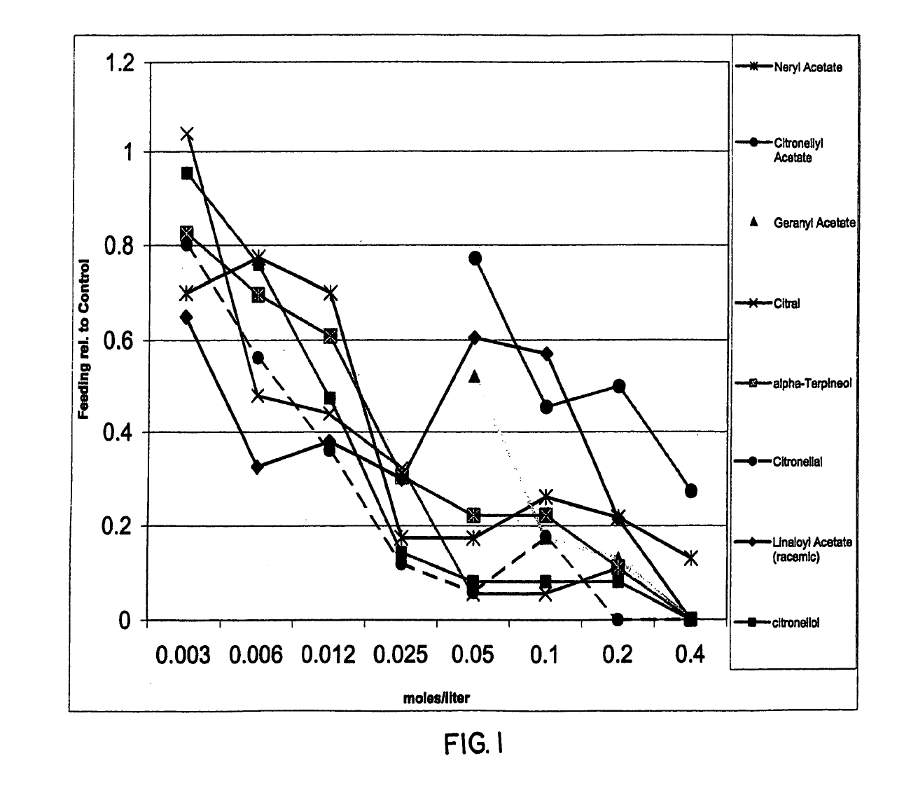

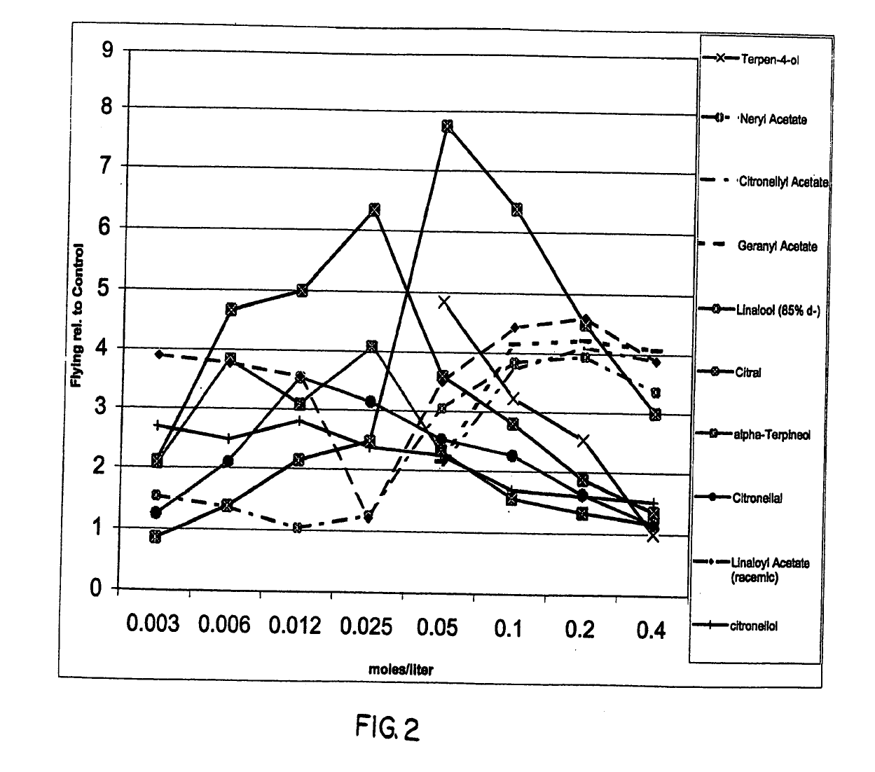

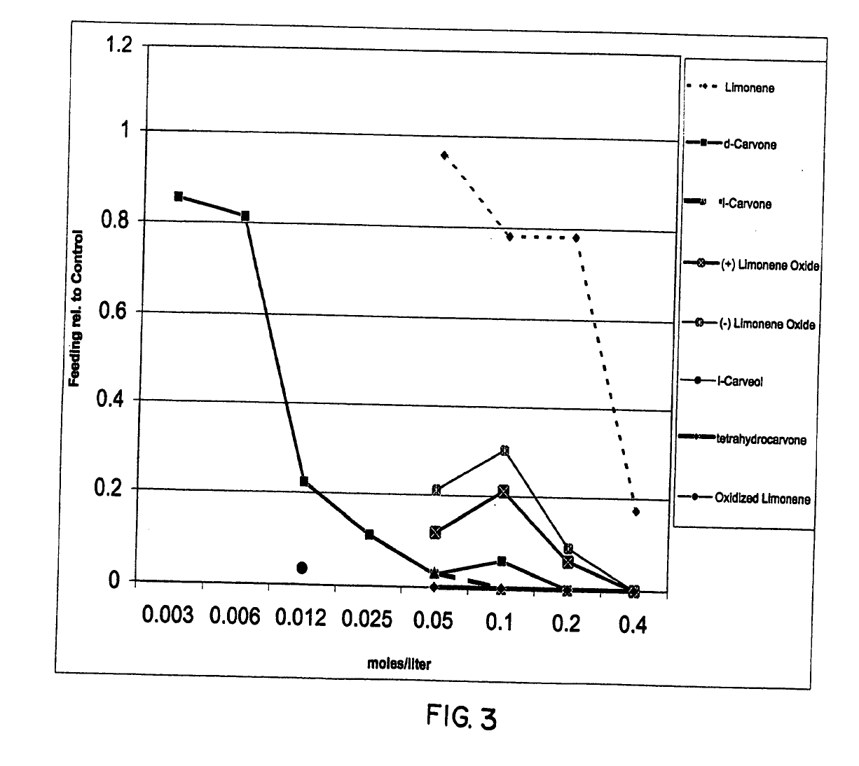

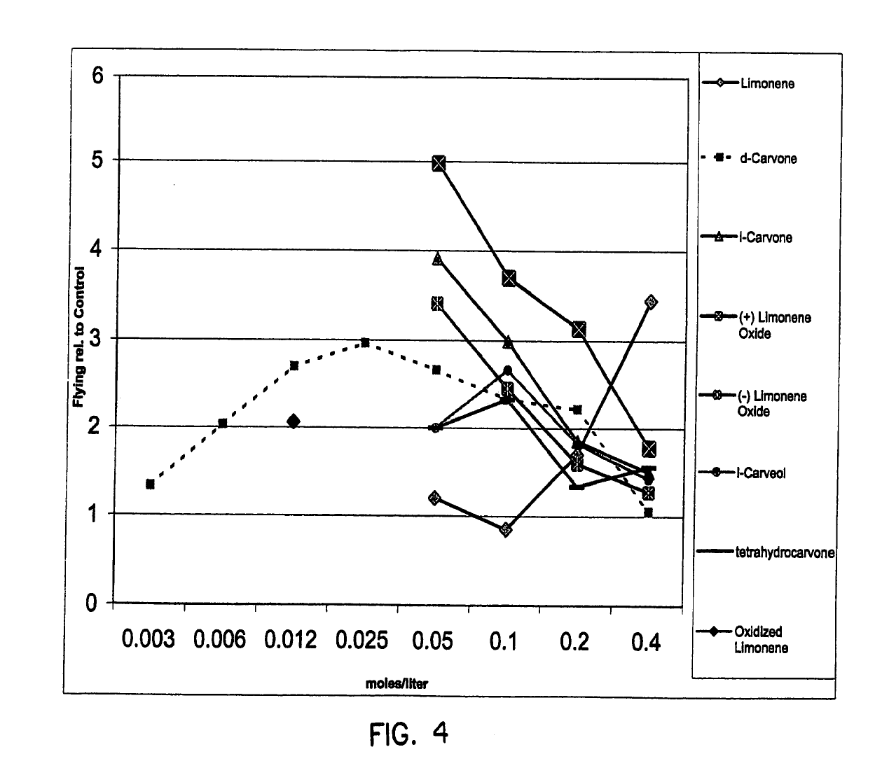

The results of the feeding tests are set forth in FIGS. 1 and 3. In the graphs of FIGS. 1 and 3, the lower the proportion feeding relative to control (1.00) is indicative of the increased repellency activity of the tested compounds. The results of the flying tests are set forth in FIGS. 2 and 4. In the graphs of FIGS. 2 and 4, the higher the number flying relative to the control (1) is indicative of the increased inhibitor activity of the tested compounds. The compounds neryl acetate, citronellyl acetate, geranyl acetate, hydroxy-p-cymene, citral, α-terpineol, terpinen-4-ol, citronellal, citronellol, d-carvone, l-carvone, linaloyl acetate, (+)/(−) limonene oxide and oxidized limonene and mixtures thereof have been found to be particularly effective as spatial inhibitors for mosquitoes and neryl acetate, citral, citronellal, linaloyl acetate, geranyl acetate, hydroxy-p-cymene, α-terpineol, d-carvone, l-carvone, (+) and (−) limonene oxide, cis and trans carveol and tetrahydrocarvone and oxidized limonene and mixtures thereof have been found to be especially effective as contact mosquito repellents.

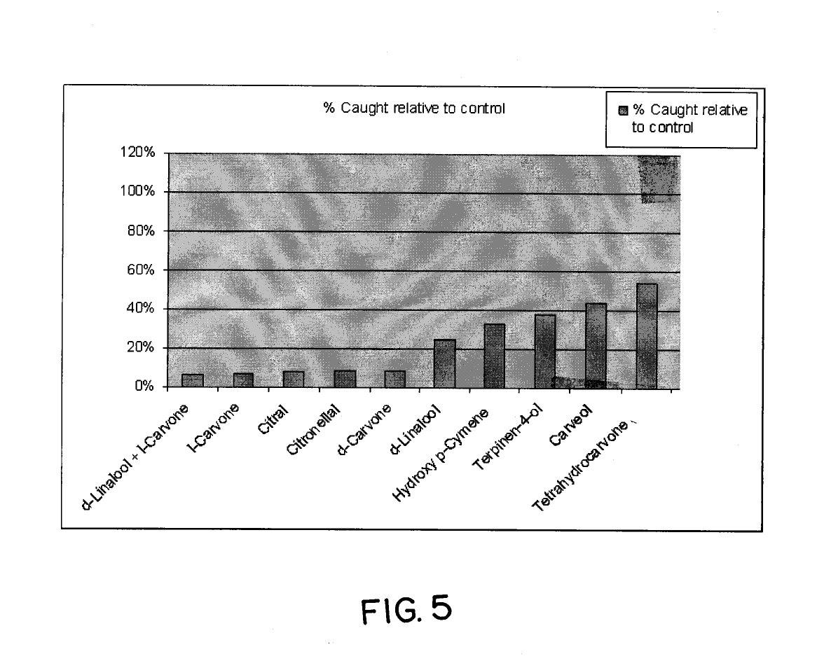

The ability of compounds of this invention to spatially inhibit the ability of mosquitoes to sense a target in the outdoors was demonstrated by the following test. Two grams of test compound was absorbed onto pieces of absorbent material. These pieces of absorbent material (fragrance release material from Rhopore Inc.) containing absorbed test compound were then placed in a stream of CO₂ and r-octenol being released from an American Biophysics Mosquito Magnet Liberty Plus mosquito trap designed to attract mosquitoes. The test were rotated over a period of 2-5 days in such a manner that both control (trap without test compound) and test compound were tested an equal number of times in each trap employed. The number of mosquitoes caught in the traps with test compounds was compared to the number of mosquitoes caught in the trap with no test compound material present. That is, the mosquitoes caught with the control were taken to be 100% catch and the catch with the test materials was calculated as a percent of mosquitoes caught relative to the control. Thus, a lowered percentage is indicative of the increasing ability of the test compounds to inhibit the ability of the mosquitoes sense the target. The results are set forth in the Table in FIG. 5. For l-carvone. l-carvone in admixture with the known spatial inhibitor d-linalool, citral, citronellal, d-carvone the percent mosquitoes caught relative to the control was in the range of about 6-8%, indicating a 90⁺% inhibition of the mosquitoes ability to sense the target trap. Somewhat less effective, but still effective inhibitors were 8-hydroxy-p-cymeme (about 34% relative catch), terpine-4-ol (about 38% relative catch), cis and trans carveol (about 43% relative catch) and tetrahydrocarvone (about 52% relative catch).

For repellency of mosquitoes, the compounds of this invention may be applied to the skin of human in any repellency effective amount. For spatial inhibition of the ability of mosquitoes to sense a target, or for spatial repellency, the compounds of this invention may be dispensed into the atmosphere in any effective amount.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

What is claimed is:

1. A method of deterring, repelling or inhibiting mosquitoes and biting midges from a human or an environmental area, the method comprising applying to the human or the environmental area a deterring/repelling/inhibiting effective amount of at least one compound selected from the group consisting of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a dial and an aldehyde, and mixtures thereof, with the proviso that for use as a mosquito and biting midge deterrent/repellent on a human, citral is not employed as the sole deterrent/repellent compound from this group of compounds, and citronellal is not employed as the sole deterrent, repellent, or spatial inhibitor compound from this group of compounds.

2. A method according to claim 1 comprising applying to the skin of the human a deterrent/repellent effective amount of at least one deterrent/repellent compound selected from the group consisting of neryl acetate, citronellyl acetate, geranyl acetate, hydroxy-p-cymene, citral, α-terpineol, citronellal, linaloyl acetate, citronellol, d- and l-carvone, (+) limonene oxide, (−) limonene oxide, cis and trans carveol, terpen-4-ol, tetrahydrocarvone, and mixtures thereof, with the proviso that citral and citronellal are not employed as the sole deterrent/repellent compounds from this group.

3. A method according to claim 2 wherein the at least one deterrent/repellent compound is selected from the group consisting of l-carvone, d-carvone, citronellal, p-hydroxy-cymene terpineol, cis and trans carveol and tetrahydrocarvone and mixtures thereof.

4. A method according to claim 3 wherein the at least one deterrent/repellent compound is selected from the group consisting of l-carvone, d-carvone and cis and trans carveol and mixtures thereof.

5. A method according to claim 2 wherein a further deterring/repelling compound is applied in combination with the at least one deterring/repellent compound.

6. A method according to claim 4 wherein a further deterring/repelling compound is applied in combination with the at least one repellent compound.

7. A method according to claim 6 wherein the further deterring/repelling compound is d-linalool.

8. A method according to claim 2 for deterring/repelling mosquitoes.

9. A method according to claim 4 for deterring/repelling mosquitoes.

10. A method according to claim 7 for deterring/repelling mosquitoes.

11. A method according to claim 1 of inhibiting the ability of mosquitoes to sense a human target in an environmental area, the method comprising dispensing into an environmental area where one want to provide such inhibiting effect an inhibiting effective amount of at least one inhibitor compound selected from the group consisting of neryl acetate, citronellyl acetate, geranyl acetate, hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and mixtures thereof.

12. A method according to claim 11 wherein the at least one inhibiting compound is selected from the group consisting of l-carvone, d-carvone, citral, citronellal, p-hydroxy-cymene, terpineol, cis and trans carveol and tetrahydrocarvone and mixtures thereof.

13. A method according to claim 12 wherein the at least one inhibiting compound is selected from the group consisting of l-carvone, d-carvone, cis and trans carveol, and mixtures thereof.

14. A method according to claim 11 wherein a further inhibiting compound is dispensed in combination with the at least one inhibiting compound.

15. A method according to claim 13 wherein a further inhibiting compound is dispensed in combination with the at least one inhibiting compound.

16. A method according to claim 15 wherein the further inhibiting compound is d-linalool.

17. A method according to claim 11 for inhibiting mosquitoes.

18. A method according to claim 13 for inhibiting mosquitoes.

19. A method according to claim 16 for inhibiting mosquitoes.

20. A composition for delivery of a deterring/repelling/inhibiting effective amount of a deterring/repelling/inhibiting compound effective against mosquitoes or biting midges, said composition comprising (a) at least one compound selected from the group consisting of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and mixtures thereof, with the proviso that for use as a mosquito and biting midge deterrent/repellent on a human, citral is not employed as the sole deterrent/repellent compound from this group of compounds, and citronellal is not employed as the sole deterrent, repellent, or spatial inhibitor compound from this group of compounds; and (b) a carrier vehicle for delivery of said at least one compound to a human or an environment.

21. A composition according to claim 20 wherein the at least one compound comprises a compound selected from the group consisting of l-carvone, d-carvone, cis and trans carveol, and mixtures thereof.

22. A composition according to claim 21 wherein the composition further comprises d-linalool.
